(19) United States
(12) Patent Application Publication
(10) Pub. No.: US 2013/0322061 A1
(43) Pub. Date: Dec. 5, 2013

(54) Artificial tree- chandelier combination

(71) Applicant: Donald M. Carpenter, Volo, IL (US)

(72) Inventor: Donald M. Carpenter, Volo, IL (US)

(21) Appl. No.: 13/507,098

(22) Filed: Jun. 4, 2012

(51) Int. Cl. F21S 6/00

(52) U.S. Cl. 362/123

(57) ABSTRACT

A Christmas tree-chandelier combination includes a chandelier assembly and a series of swag assemblies. The chandelier assembly includes a vertical support structure, and a series of lamp assemblies equal in number to the swag assemblies. Each swag assembly includes a spine element, a series of re-positionable, twistable branchlike structures, and swag-based fastening structures such as hooks for removably fastening the respective swag assemblies to the vertical support structure. The spine has a primary spine axis and a spine length. The branchlike structures are connected to the spine and extend radially outward therefrom along the spine length. Each swag assembly is attachable to the vertical support structure and the branchlike structures are positionable relative to one another for subtending a series of angles about the primary spine axis and defining a treelike sector. Together, the treelike sectors effect a treelike appearance about the vertical support structure.

### BACKGROUND OF THE INVENTION

1. Field of the Invention

The present invention generally relates to certain means for outfitting a chandelier or other articles having a central support element with ornamentation. More particularly, the present invention relates to an apparatus for outfitting a vertical support structure with ornamental branch-like element(s) so as to convert the outward appearance of the vertical support structure into an ornamental tree-like construction.

2. Description of Prior Art

U.S. Pat. No. 6,435,463 ('463 patent), which issued to Zezza discloses a System and Method for Suspending a Tree. The '463 patent describes a system of suspending a tree includes a hook secured to an overhead support such as a ceiling joist or beam or structure dedicated to this purpose. A swivel is then secured to the hook. A tree grip is secured to the swivel and then to the main leader of the Christmas tree. The tree will then hang plumb due to the force of gravity.

Optionally, a pulley may be employed to assist in the raising of the tree. The pulley is secured to the hook by a loop. The tree grip is secured to the top of the tree. A cable is securely attached to the trunk of the tree below the apex of the tree. The cable is threaded through the sheave of the pulley and may be pulled to raise the tree until the tree grip can be attached to the hook. The free end of the cable may then be attached to the trunk of the tree to provide additional security of attachment.

U.S. Pat. No. 7,314,202 ('202 patent), which issued to Everett et al., discloses System for Suspending Decorative Trees. The '202 patent describes a hanging assembly for suspending a decorative tree, such as a Christmas tree, from an overhead support and a method of suspending a decorative tree from an overhead support are provided. An anchor is installed into the overhead support structure.

A suspension member extends downwardly from the anchor. A tree engaging member is attached to a structural member of the tree and is engaged to the lower end of the suspension member in a manner that facilitates easy positioning and adjustment of the suspension height of the tree. In this manner the tree is displayed in a structurally secure and balanced way virtually eliminating the possibility that the tree be overturned.

United States Patent Application No. 2004/0076007, which was authored by Hamazaki., describes a decorative wall hanging is made up of a substantially flat pliable matrix comprised of intertwined cords, such as a macrame or knitted matrix. The pliable matrix defines a pattern of regularly spaced openings, with each opening defined by adjacent ones of the cords. The matrix has a front side and a back side, and defines an outline of a decorative shape.

The wall hanging may include a plurality of miniature lights interconnected by a wire, with each of the miniature lights inserted through one of the openings so as to be visible from the front side of the matrix with the wire running along the back side of the matrix. The wall hanging may also include a rigid bar removably attached to the back side of the matrix, to maintain the wall hanging in the desired shape. In an embodiment of the invention, the decorative effect of the wall hanging is that of a lighted Christmas tree.

United States Patent Application No. 2004/0160779, which was authored by Nielson describes a reconfigurable chandelier includes fixed components and a plurality of removable and interchangeable decorative adornments. The adornments each include at least one magnet that magnetically couples the adornment to a portion of the chandelier.

Some or all of the set of interchangeable adornments may be interchanged to provide the chandelier with a different appearance. The adornments may be of different shapes, sizes, and colors. The adornments may include multiple pieces coupled together and to the magnet using wire, string, chain or metal links. The chandelier may be easily disassembled and reassembled by removing and replacing the adornments for cleaning or to change the appearance of the chandelier.

United States Patent Application No. 2005/0037157, which was authored by Hsu., describes a suspensible flat Christmas tree comprises at least one triangular frame, a hanger mounted on a top of the Christmas tree, a stand for supporting the at least one frame in an upright position, and at least one branch wrapped and interlaced on the frame and defining a plurality of hanging cavities for hanging gifts therein.

United States Patent Application No. 2007/0263397, which was authored by Nielson describes a reconfigurable lighting fixtures, household apparatuses and household fixtures include fixed components and a plurality of removable and interchangeable decorative adornments. The adornments each include at least one magnet that magnetically couples the adornment to a portion of the fixture or apparatus. Some or all of the set of interchangeable adornments may be interchanged to provide the fixtures or apparatus with a different appearance.

The adornments may be of different shapes, sizes, and colors and they may be coupled to various non-fixed locations. The adornments may include multiple pieces coupled together and to the magnet using wire, string, chain or metal links. The fixtures or apparatus may be easily disassembled and reassembled by removing and replacing the adornments for cleaning or to change the appearance thereof. The fixture/apparatus may be a chandelier, candle holder, sconce, lamp, bobeche, tract lighting, ceiling fan, curtain rod, lampshade and the like.

It will be seen from an inspection of the prior art that the prior art perceives a need for a hand-wearable glove construction that functions to interface intermediate a user's hand and an electronic device so as to enable the wearer of the glove construction to more easily carry or transfer the electronic device.

### SUMMARY OF THE INVENTION

To achieve these and other readily apparent objectives, the present invention essentially provides a glove construction and/or kit may be used to outfit an electronic device, such as a laptop computer, tablet, or e-reader, so that the user thereof may more easily carry or transport the device. The glove construction comprises a flexible, load-bearing, strap-like material member having a glove length and a glove width. A series of finger-receiving sleeves extend widthwise intermediate the glove length.

The ends of the material member are outfitted with a first set of fasteners matable with a second set of fasteners outfitted upon the electronic device. The first and second sets of fasteners are matable and together form a fastener interface for removably attaching the glove construction to the electronic device. The glove construction and the fastener interface are supportable of the device weight, and thus enable the user to manually carry the electronic device via the glove construction by inserting a series of fingers into the finger-receiving sleeves and lifting the combination therewith.

The series of finger-receiving sleeves preferably number three such that the three finger-receiving sleeves function to receive the user's index finger, the user's middle finger, and the user's ring finger, thereby leaving the user's thumb and small finger outside the glove. The glove ends effectively function to interface intermediate the user's thumb and small finger and the electronic device.

The glove construction may be easily formed doubling over an elongate load-bearing strap-like material, and forming the finger-receiving sleeves by fastening opposed sections of the material member together widthwise. The glove construction may thus be said to preferably comprise a double-layered material member with finger-receiving sleeves, each of which preferably further define a finger-receiving axis, the finger-receiving axes being non-parallel for ergonomic enhancement.

### BRIEF DESCRIPTION OF THE DRAWINGS

Other features of MY invention will become more evident from a consideration of the following brief description of patent drawings:

FIG. 1 is a first diagrammatic depiction of a combination tree-chandelier assembly according to the present invention, which tree-chandelier assembly is shown hanging from a ceiling above a dinette set.

FIG. 1(a) is an enlarged fragmentary exploded depiction of a select lamp assembly junction site showing a primary bulb, a coupler socket construction and lamp support, and a light string for attachment to the coupler socket construction.

FIG. 2 is a second diagrammatic depiction of the combination tree-chandelier assembly according to the present invention, which tree-chandelier assembly is shown hanging from a ceiling above a dinette set with parts removed to show an inner otherwise hidden chandelier assembly.

FIG. 3 is a side view of a simplified swag assembly according to the present invention depicting a series of branchlike structures of varying lengths extending radially outward from the spine along the spine length.

FIG. 4 is a first axial view of a simplified swag assembly according to the present invention depicting a series of branchlike structures of varying lengths extending radially outward from the spine axis.

FIG. 5 is a second diagrammatic axial view of a simplified swag assembly according to the present invention with branchlike structures removed to demonstrate how branchlike structures may be repositioned to subtend a series of varied angles relative to the spine axis.

FIG. 6 is a first diagrammatic axial view of a simplified swag assembly according to the present invention outfitted upon a chandelier assembly with branchlike structures removed to demonstrate how the branchlike structures may be repositioned to subtend a series of varied angles relative to the spine axis and the lamp assemblies.

FIG. 6(a) is an enlarged second diagrammatic axial view as enlarged from FIG. 6 to demonstrate in greater detail the structural relationship between the chandelier assembly along its chain and the swag assemblies.

FIG. 6(b) is an enlarged diagrammatic side view of the structures otherwise depicted in FIG. 6(a) demonstrating in greater detail the structural relationship between the chandelier assembly along its chain and the swag assemblies.

FIG. 7 is a third diagrammatic axial view of a simplified swag assembly according to the present invention with branchlike structures removed to demonstrate how branchlike structures may be repositioned to subtend 180 degrees relative to the spine axis.

FIG. 7(a) is a diagrammatic side view of a possible combination tree-chandelier assembly according to the present invention showing an assembly having two lamp assemblies.

FIG. 8 is a fourth diagrammatic axial view of a simplified swag assembly according to the present invention with branchlike structures removed to demonstrate how branchlike structures may be repositioned to subtend 60 degrees relative to the spine axis.

FIG. 8(a) is a diagrammatic side view of a possible combination tree-chandelier assembly according to the present invention showing an assembly having six lamp assemblies.

FIG. 9 is a fifth diagrammatic axial view of a simplified swag assembly according to the present invention with branchlike structures removed to demonstrate how branchlike structures may be repositioned to subtend 45 degrees relative to the spine axis.

FIG. 9(a) is an enlarged diagrammatic axial view as enlarged from FIG. 9 to demonstrate in greater detail the structural relationship between the chandelier assembly along its chain and the swag assemblies at a loop to chain junction site wherein a cord connects loop elements for forcing the spine axes toward one another.

FIG. 9(b) is an enlarged fragmentary sectional view as sectioned from FIG. 9 to demonstrate in greater detail the structural relationship between twistable leaf structures of the branchlike structures for interconnecting adjacent swag assemblies.

FIG. 9(c) is an enlarged fragmentary view demonstrating in greater detail the structural relationship between twistable branchlike structures for interconnecting adjacent swag assemblies.

FIG. 10 is enlarged fragmentary sectional view of an upper portion of a first alternative embodiment according to the present invention depicting a vertical support structure of a chandelier assembly with a collar element/assembly attached thereto, and opposed swag assemblies attached to the collar element.

FIG. 11 is enlarged axial view of the first alternative embodiment according to the present invention depicting a prior art central sectioned vertical support structure of a chandelier assembly surrounded by a collar element/assembly, and a series of swag assemblies radiating from, and attached to the collar element/assembly.

FIG. 12 is enlarged axial view of a second alternative embodiment according to the present invention depicting a prior art central sectioned vertical support structure of a light assembly having a circular outer surface and inner wiring surrounded by a collar element/assembly according to the present invention.

FIG. 13 is enlarged axial view of the second alternative embodiment according to the present invention depicting a prior art central sectioned vertical support structure of a light assembly having a non-circular outer surface and inner wiring surrounded by a collar element/assembly according to the present invention.

FIG. 14 is a fragmentary mid-sectional side view of two swag assemblies according to the present invention structurally situated in laterally opposed relation relative to a section of a phantom chain-type vertical support structure of a chandelier assembly to show loop elements of the swag assemblies being pulled toward one another via a tensioned cord element.

FIG. 15 is a fragmentary mid-sectional side view of two swag assemblies according to the present invention structurally situated in laterally opposed relation relative to a section of a phantom chain-type vertical support structure of a chandelier assembly to show hook elements of the swag assemblies for hook-engaging the mid-sectional portions of the swag assemblies to the chain-type vertical support structure.

FIG. 16 is a diagrammatic side view type depiction of the second alternative embodiment according to the present invention depicting two fragmentary swag assemblies shown laterally opposed to a lamp post assembly and connected thereto via a collar element/assembly according to the present invention.

FIG. 17 is an enlarged fragmentary sectional side view of an upper portion of the structures otherwise shown in FIG. 16 depicting spine elements of the swag assemblies with a primary spine axis and a secondary spine axis oblique relative to the primary spine axis.

FIG. 18 is a reduced diagrammatic depiction of the structures otherwise shown in FIG. 18 to show the relative size of the structures compared to a stick figure representing a human being.

### DETAILED DESCRIPTION OF THE PREFERRED EMBODIMENT

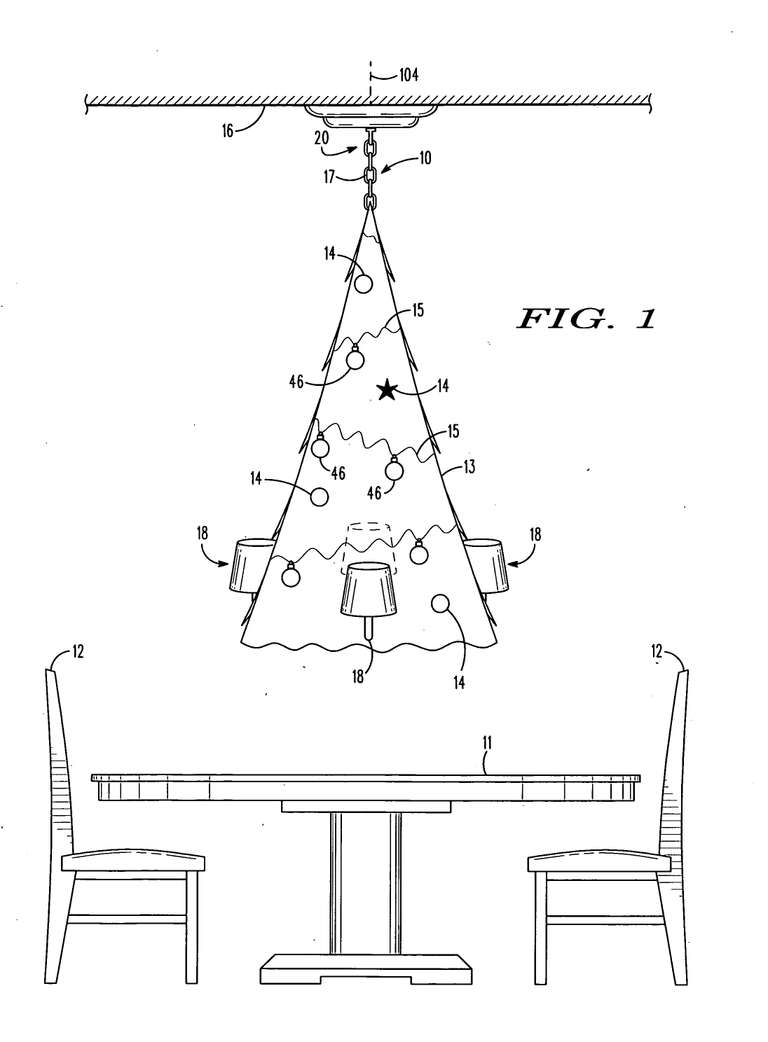

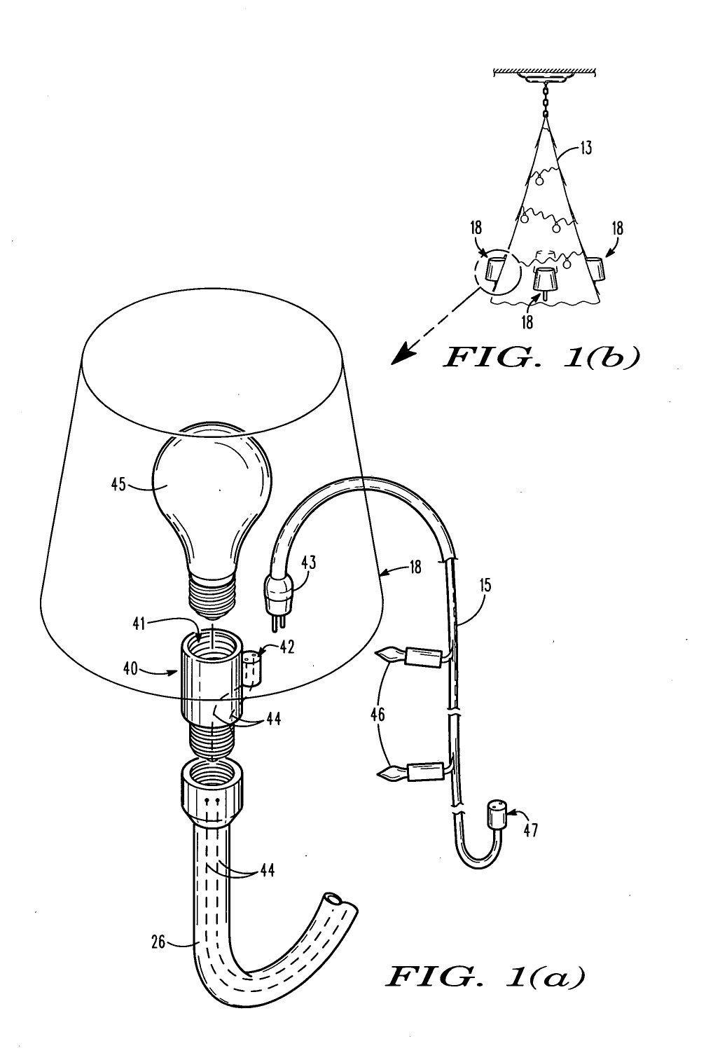

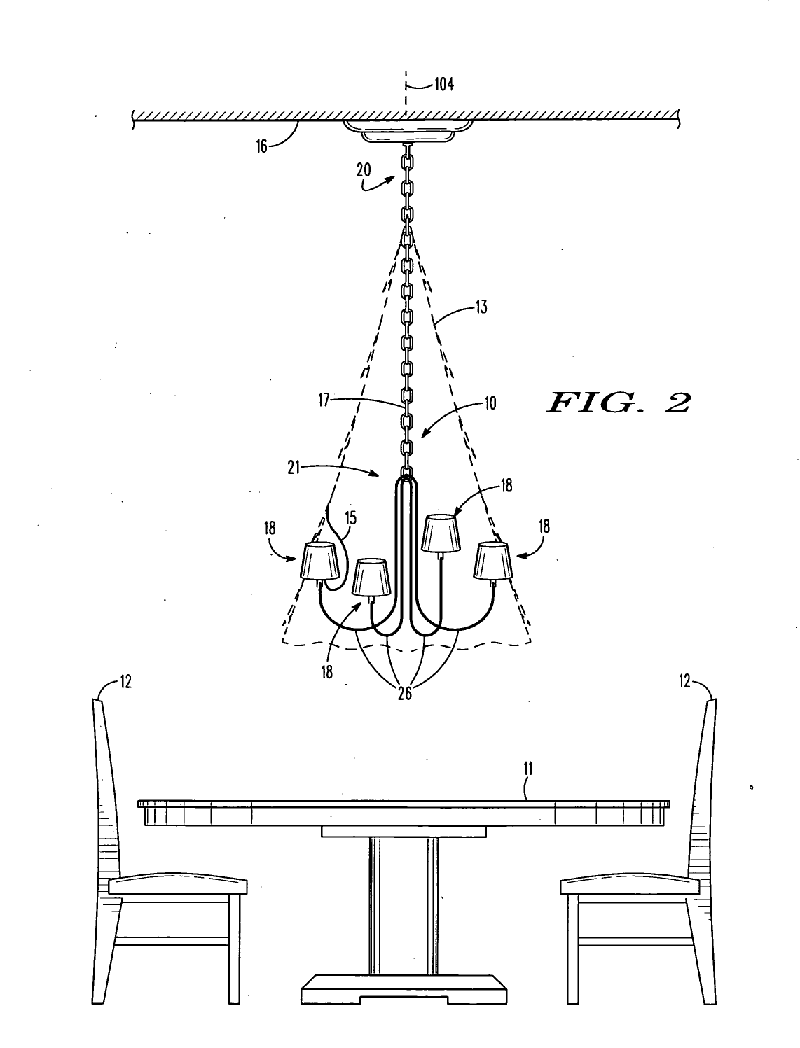

Referring now the drawings with more specificity, the present invention provides an artificial tree-chandelier combination or lamp-tree assembly, which assembly or combination was conceived with a view toward ornamenting the room/space in which the lamp, light fixture or chandelier is located. Referencing FIGS. 1 and 2, for example, it will be seen that a chandelier assembly 10 hangs from a ceiling 16 above a dinette set including a table 11 and opposed chairs 12.

The present invention was born out of the idea to ornament the chandelier assembly 10 with Christmas type decorations, thereby transforming the chandelier assembly 10 into the semblance of an artificial tree (e.g. Christmas tree) type configuration as at 13, which configuration 13 can then be further decorated as desired by the user. For example the artificial tree type configuration 13 may be decorated with ornaments as at 14 and/or a light string assembly as at 15.

It is contemplated that the present invention may comprise in combination the light string assembly and certain circuit means for delivering The light string assembly 15 a select lamp assembly comprises circuit enabling means for enabling electrical communication with the light string 15 directly from the circuitry of the lamp assembly 18 or chandelier assembly 10. The circuit enabling means thus enables a user to selectively ornament the artificial tree-chandelier combination with illumination as generally depicted in FIG. 1.

FIG. 1(a) depicts an exemplary diagrammatic circuit assembly for enabling the user to deliver current to the light string 15. A coupler socket assembly as at 40 is depicted and comprises a primary bulb socket 41 and a secondary string socket as at 42. The light string 15 may be outfitted with a plug as at 43 for insertion in the secondary string socket 42. Both sockets 41 and 42 are in electrical communication with circuitry 44 for delivering current to both the primary bulb 45 (or other illumination means) of the lamp assembly 18, and the secondary bulbs 46 (of other illumination means) of the light string 15. The light string may comprise tertiary sockets 47 for connecting additional light strings 15.

The chandelier assembly 10 according to the present invention preferably comprises a vertical support structure or member, and at least two lamp assemblies or light fixtures as at 18. It is contemplated that the vertical support structure or member may take the form of either a chainlike structure as at 17 or a rodlike or postlike member as at 19. The lamp assemblies or light fixtures 18 are extended or supported by way of lamp or light support structures as at 26.

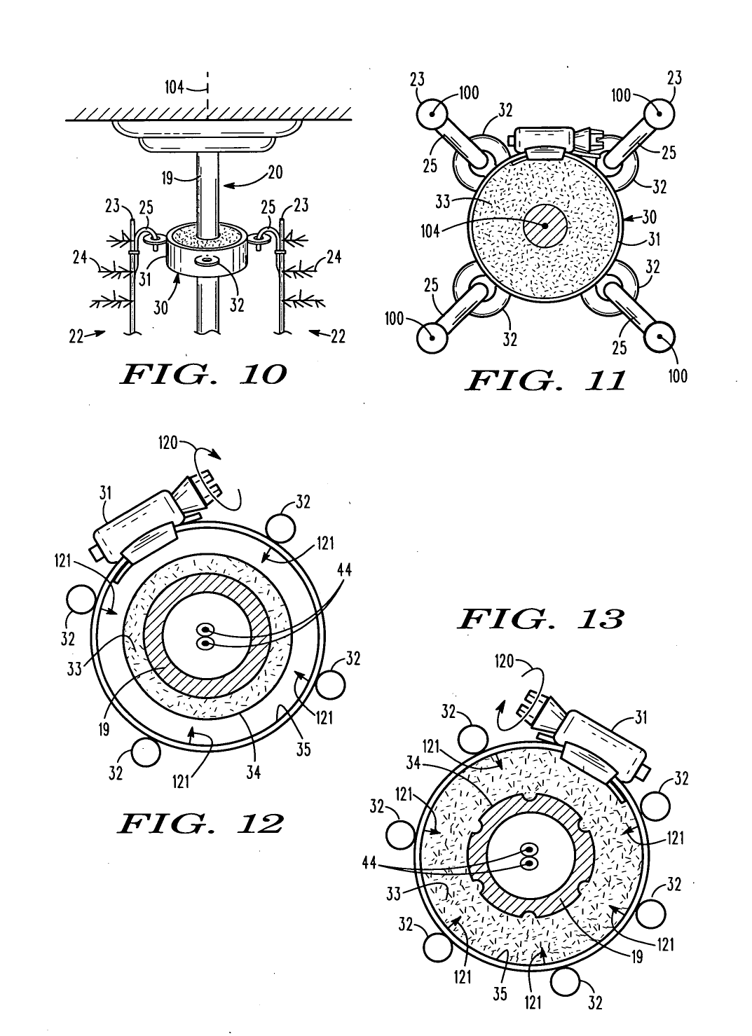

The vertical support structure inherently comprises an upper portion 20 and a lower portion 21. In the preferred embodiment according to the present invention (i.e. when used in combination with a chandelier assembly 10), the lamp assemblies 18 extend radially outwardly from the vertical support structure (i.e. chain 17 as in FIGS. 1 and 2, or rodlike structure 19 as in FIG. 10) at the lower portion 21.

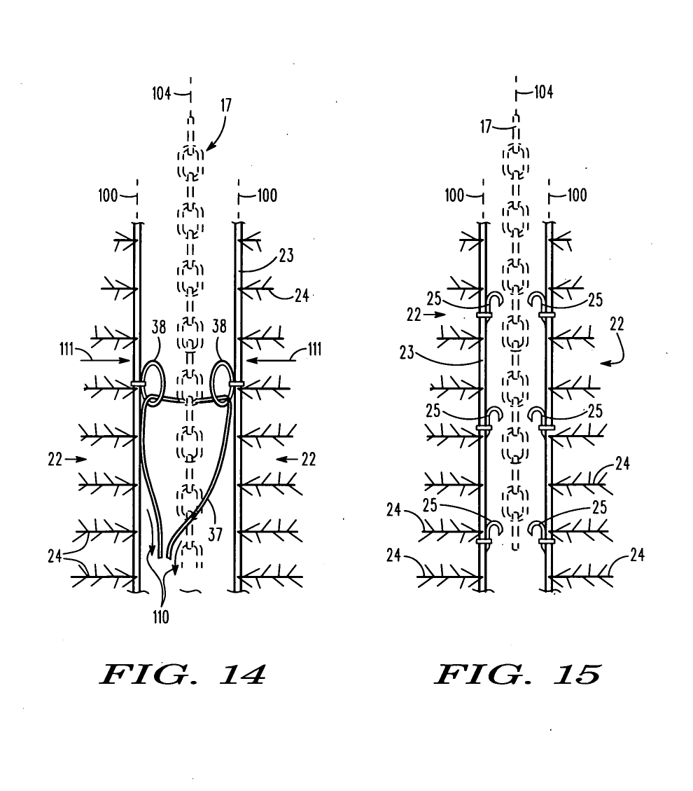

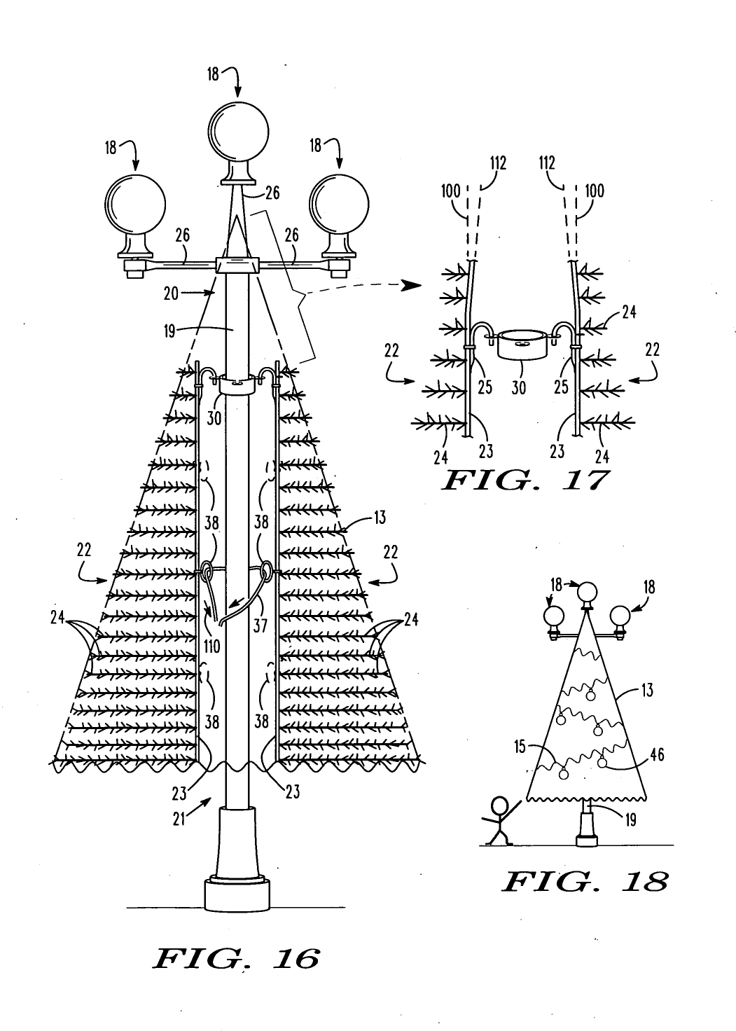

In an alternative embodiment, as generally depicted in FIGS. 14 and 16, it is contemplated that the lamp assemblies or light fixtures 18 may extend outwardly from the vertical support structure at or from the upper portion 20. Notably, the alternative embodiment depicted in FIGS. 14 and 16 contemplates a street lamp type construction. Such constructions may support any number of lamp assemblies or light fixtures 18, which fixtures 18 may extend from the axis of the vertical support member in any number of directions via the light support structures 26.

Central to the practice of the present invention is a swag assembly as at 22. Each swag assembly preferably comprises a spine element as at 23, a series of branchlike structures extending from the spine element as at 24, and swag-based fastening means for fastening the respective swag assembly 22 to the vertical support structure. It is contemplated that the preferred swag-based fastening means may be exemplified by a hook or series of hooks as at 25 fastened to the spine element 23 and extending in a direction generally opposite the branchlike structures 24.

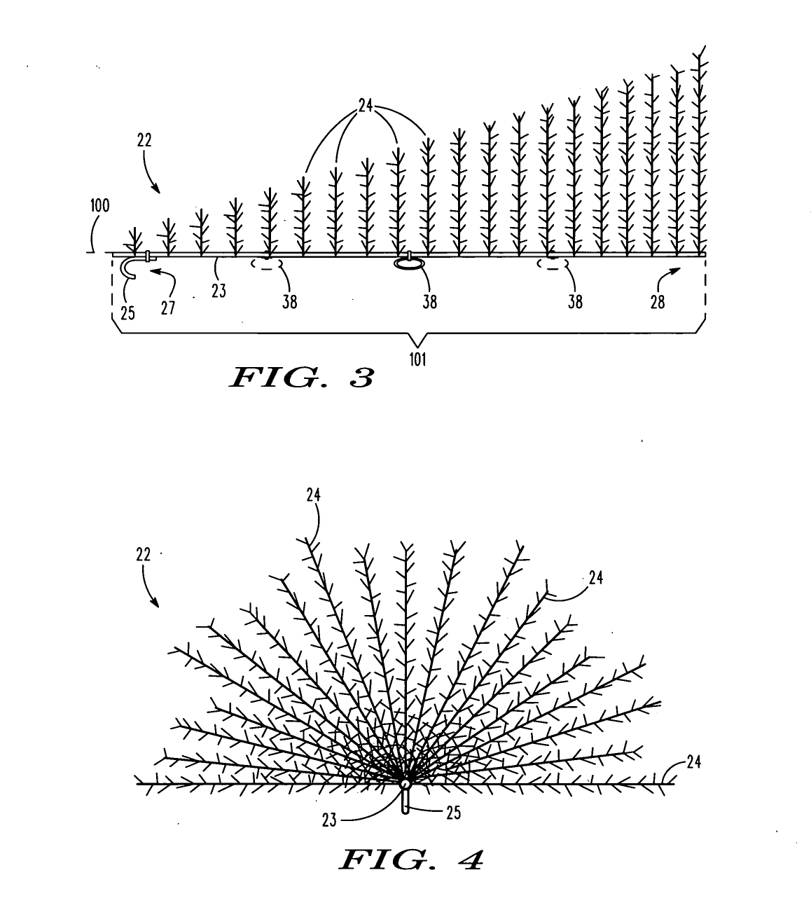

The spine element 23 comprises a primary spine axis as at 100 and a spine length as at 101 and may be formed by bendable wire or a series of wires (i.e. the ends of the branchlike structures 24). The series of branchlike structures 24 (formed, for example, by bendable wire) preferably extend radially outward from the primary spine axis 100 along the spine length 101 as generally and comparatively depicted in FIGS. 3 and 4.

The branchlike structures 24 preferably comprise (needlelike) twistable leaves or structure as at 36, which twistable leaves or structure 36 of adjacent swag assemblies 22 are twist-connectable (as at 109) for closing or camouflaging a seam intermediate adjacent swag assemblies 22. In other words, the twistable leaves 36 or (twistable branchlike structures 24) may provide the dual function of fastening together adjacent swag assemblies 22 while simultaneously improving the appearance of the treelike configuration 13.

In keeping with the notion that the treelike configuration 13 should be enhanced as much as possible, the present invention further contemplates at least one cord element as at 37 and at least one loop element as at 38. The loop elements 38 are fastened to the spine element and positioned intermediate the upper swag ends 27 and the lower swag ends 28. The cord element 27 functions to interconnect a series of swag assemblies 22 via the loop elements 38 and may be tightened or pulled or tensioned or forced as at vectors 110 for forcing the spine axes 100 toward one another and/or the axis 104 of the vertical support structure thereby adjusting the effective girth (as at 111) of the treelike configuration 13.

From a comparative inspection of FIGS. 14 and 15 it will be seen that certain treelike configuration maintenance means, as exemplified by the loop-cord combination specified above, may also be exemplified by a series of hook elements 25 attached to the spine element 23 for attachment to link elements 29 (or similar other hook-receiving elements as at 32) for maintaining the spine element 23 in substantially parallel alignment with the axis 104. Thus it is contemplated that the present invention incorporates the use of certain configuration or girth maintenance means as exemplified by the foregoing.

Each swag assembly 22 is attachable to the vertical support structure via the swag-based fastening means as exemplified by hook(s) 25. The branchlike structures 24 are preferably positionable (as at arrows 102) relative to one another for subtending a series of angles about the primary spine axis 100 and defining a treelike (i.e. circular) sector as at 103. The treelike sectors 103 occupy the space or extend intermediate the lamp assemblies 18 for effecting a treelike appearance or treelike configuration 13 about the vertical support structure.

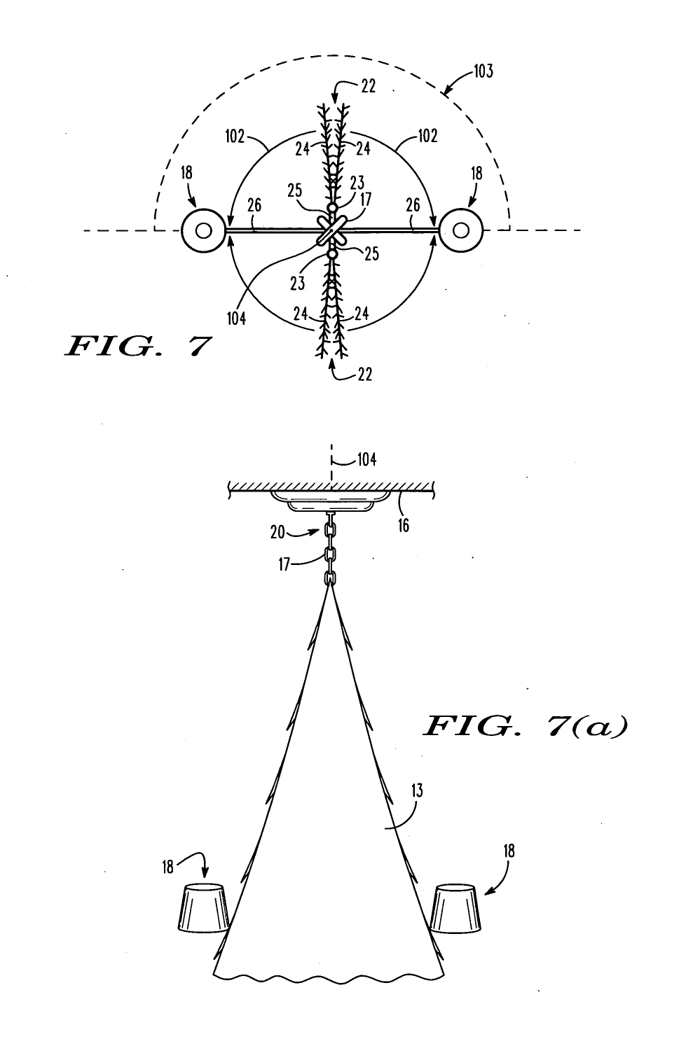

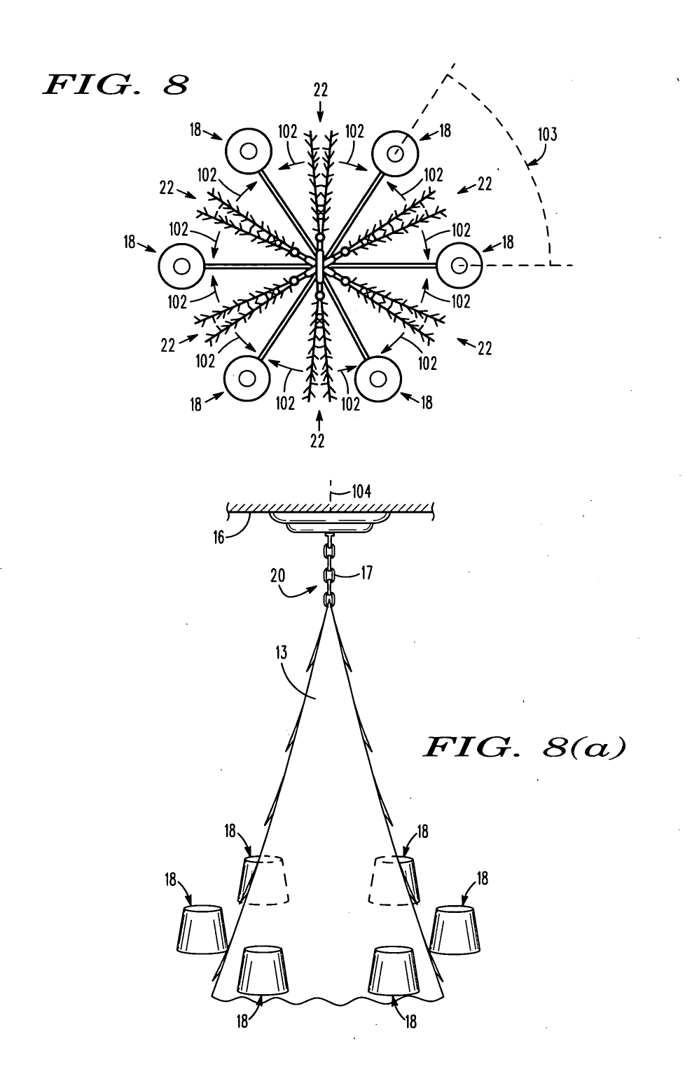

It is contemplated that the treelike sectors 103 will necessarily depend on the number of lamp assemblies or light fixtures 18 extending from the vertical support structure in the preferred embodiment. Referencing FIGS. 7 and 7(a) versus FIGS. 8 and 8(a), the reader will comparatively note that the basic chandelier construction contemplates (a) at least two lamp assemblies 18 as depicted in FIGS. 7 and 7(a), and (b) an example of six lamp assemblies 18 as depicted in FIGS. 8 and 8(a).

Two swag assemblies 22 are thus contemplated to fill the space intermediate the lamp assemblies 18 in FIGS. 7 and 7(a). The branchlike structures 24 of the two swag assemblies 22 are positioned as at 102 to subtend roughly 180 rotational degrees so as to occupy the space or extend intermediate the lamp assemblies 18 positioned roughly 180 rotational degrees from one another about the axis 104 of the vertical support structure. The sectors 103 in FIG. 7 are substantially semicircular.

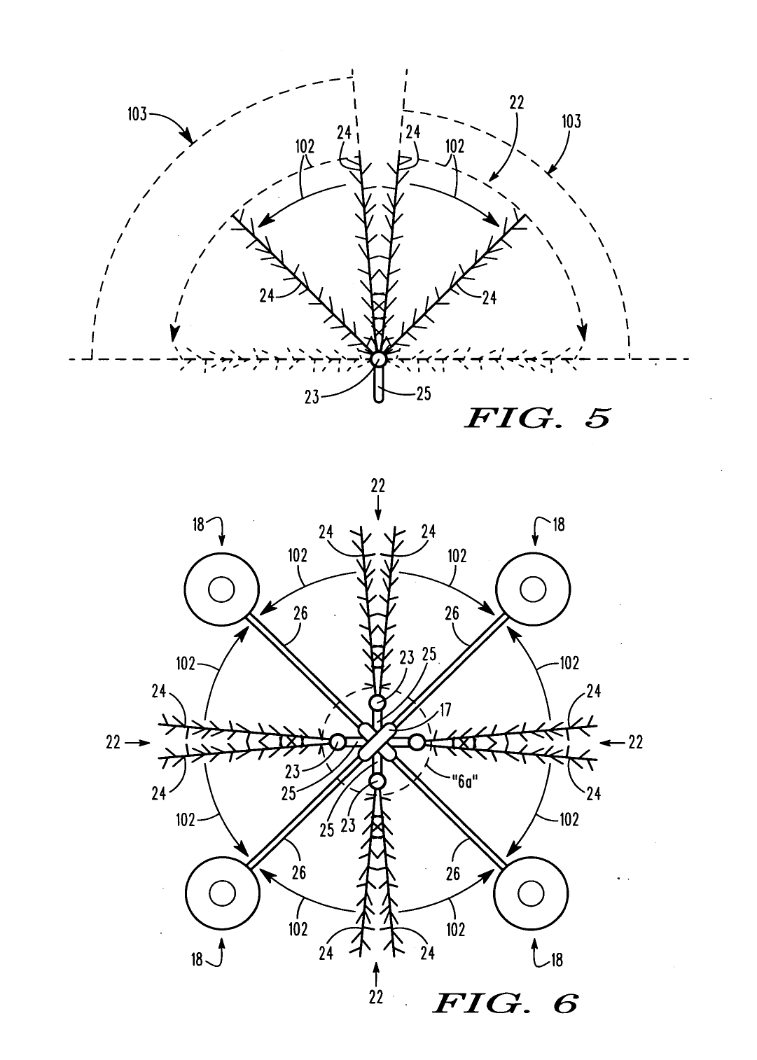

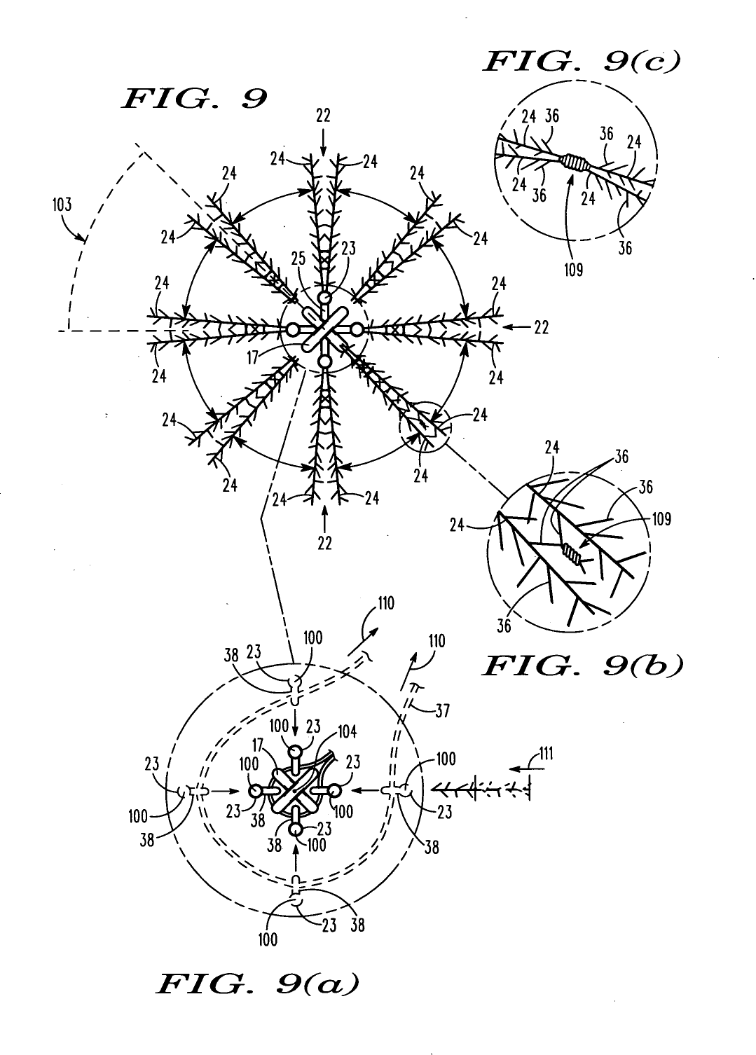

By way of comparison, six swag assemblies 22 are contemplated to fill the space intermediate lamp assemblies 18 in FIGS. 8 and 8(a). The branchlike structures 24 of the six swag assemblies 22 are positioned as at 102 to subtend roughly 60 rotational degrees so as to occupy the space or extend intermediate the lamp assemblies 18 positioned roughly 60 rotational degrees from one another about the axis 104 of the vertical support structure. The sectors 103 in FIG. 7 are sextants. The sectors 103 in FIG. 5 are quadrants and the sectors 103 in FIG. 9 are octants.

It has been noted that the vertical support structure according to the preferred embodiment is exemplified by a chain 17 and the respective swag-based fastening means are exemplified by hooks 25. Accordingly, the swag assemblies 22 each preferably comprise an upper swag end as at 27 and a lower swag end as at 28, and the chain 17 preferably comprises a series of links as at 29.

The links 29 each extend in a respective link plane as at 105. The link planes 105 of successive links 29 are substantially orthogonal to one another. The hooks 25 of at least two swag assemblies 22 extending through an upper link as at 29′ (twenty-nine prime) in opposing directions flanking a lower link as at 29″ (twenty-nine double prime) and extend in respective hook planes as at 106 substantially parallel to one another and the link plane 105 of the lower link 29″.

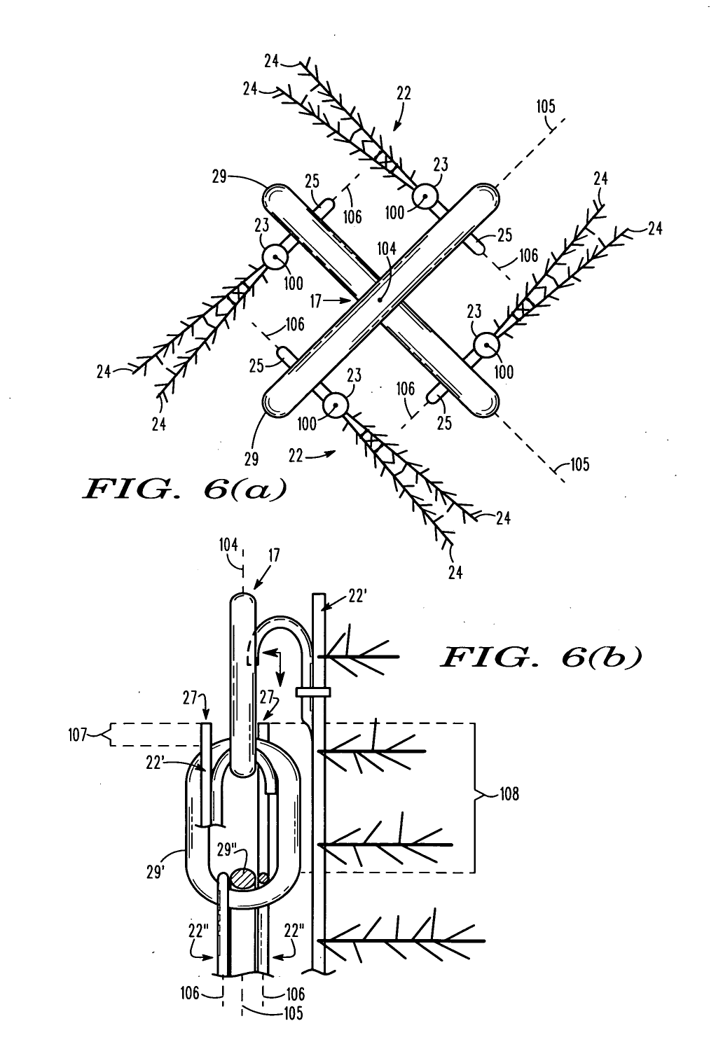

Referencing FIGS. 6(a) and 6(b), the reader will consider the case of four lamp assemblies 18 and/or four swag assemblies 22. It is contemplated that the four lamp assemblies 18 may extend radially outwardly from the primary spine axis 100 at a number of rotational degrees from one another. The four swag assemblies 22 may comprise a pair of upper link swag assemblies as at 22′ (twenty-two prime) and a pair of lower link swag assemblies as at 22″ (twenty-two double prime).

The lower link swag assemblies 22″ each preferably comprise hooks 25 positioned at a first distance 108 from the upper swag end 27, and the upper link swag assemblies 22′ each preferably comprise hooks 25 positioned at a second distance 107 from the upper swag end 27. The first distance 108 is greater than the second distance 107 such that when the swag assemblies 22′ and 22″ are fastened to the vertical support structure the upper swag ends 27 are uniformly positioned about the vertical support structure (e.g. chain 17).

It is contemplated that not all vertical support structures will be defined by chain assemblies (as at 17), but rather some vertical support structures may be defined by singular or unitary rodlike or postlike structures as at 19. An alternative combination or feature according to the present invention thus contemplates a support structure collar as at 30. It is contemplated that the collar 30 may be included in the design whenever the vertical support structure does not, in and of itself, provide hook-receiving means as do links 29.

The support structure collar 30 may preferably comprise certain collar-based fastening means (as exemplified by a hose clamp 31) for fastening the support structure collar 30 to the vertical support structure (e.g. structure(s) 19) and a series of outwardly extending hook-receiving structures as at 32. The hook receiving structures 32 are cooperable with the hooks 25 for fastening the swag assemblies 22 to the vertical support structure via the support structure collar 30.

Certain gasket means (e.g. compressible foam or rubber material) may interface intermediate the vertical support structure (e.g. structure 19) and the collar-based fastening means (e.g. pipe clamp 31). The gasket means as at 33 enhance securement of the support structure collar 30 to the vertical support structure by enhancing contact surface area and static friction between the elements when the collar-based fastening means are tightened about the vertical support structure (as at 120 thereby forcing the device/means inward as at 121).

It is contemplated that the outer surface of the vertical support structure may not be entirely smooth or may comprise surfacing (as at 34) that does not match or conform to the opposing surfacing (as at 35) of the collar-based fastening means. Accordingly, it is contemplated that certain gasket means 33 will fill the non-conforming space therebetween and thus function to enhance the securement of the collar 30 to the vertical support structure.

The spine element 23 may further comprise a secondary spine axis as at 112. It is contemplated that in certain structural situations, varied axes may be necessary in order to achieve a natural looking treelike configuration 13. Accordingly, it is contemplated that the spine element 23 may comprise both a primary spine axis that will extend substantially parallel to the vertical support structure and a secondary spine axis 112 that will extend obliquely relative to the primary spine axis 100 so as to adjust the radial extent of the branchlike structures 24 at those regions of the overall assembly that may require adjustment as generally and comparatively depicted in FIGS. 16 and 17.

While the above description contains much specificity, this specificity should not be construed as limitations on the scope of the invention, but rather as an exemplification of the invention. For example, it is contemplated that the present invention essentially provides a lamp-tree assembly for ornamenting a given space. The lamp-tree assembly essentially comprises a lamp assembly and a series of swag assemblies as at 22. The lamp assembly comprises a vertical support structure and a light fixture as at 18. The vertical support structure comprises upper and lower portion, and supports the light fixture.

Each swag assembly comprises a spine element, a series of branchlike structures extending from the spine element, and certain swag-based fastening means for fastening each swag assembly to the vertical support structure of the lamp assembly. The spine element (or assembly) has a primary spine axis and a spine length. The series of branchlike structures extend radially outward from the primary spine axis along the spine length.

Each swag assembly is (removably) attachable or fastenable to the vertical support structure via said swag-based fastening means. The branchlike structures are positionable relative to one another for subtending a series of angles about the primary spine axis and defining a treelike sector. Together, the treelike sectors surround the vertical support structure for effecting a treelike appearance thereabout.

The swag assembly according to the present invention inherently comprises an upper swag end and a lower swag end. The swag-based fastening means, as exemplified by a hook element, are connected to the spine at least at the upper swag end, and extend in a direction opposite the branchlike structures for attachment to a chain-based or chain-type vertical support structure.

A series of hooks may also be connected to the spine element in spaced relation from the upper swag end to the lower swag end as generally depicted in FIG. 15. The hooks 25 in such an arrangement may perform a function akin to the cord and loop elements earlier specified insofar as the hooks tend to maintain the spine axes in parallel relation relative to the axis 104 of the vertical support member when cooperably engaged with a series of structurally corresponding chain links.

Accordingly, although the invention has been described by reference to certain preferred embodiments, it is not intended that the lamp-tree assembly herein presented be limited thereby, but that modifications thereof are intended to be included as falling within the broad scope and spirit of the foregoing disclosure, the following claims and the appended drawings.

I claim:

1. An artificial tree-chandelier combination, the artificial tree-chandelier combination for ornamenting a room, the artificial tree-chandelier combination, comprising:
a chandelier assembly, the chandelier assembly comprising a vertical support structure, and at least two lamp assemblies, the vertical support structure comprising an upper portion and a lower portion, the lamp assemblies extending radially outwardly from the vertical support structure at the lower portion; and
at least two swag assemblies, each swag assembly comprising a spine, a series of branchlike structures, and swag-based fastening means for fastening the swag assembly to the vertical support structure, the spine having a primary spine axis and a spine length, the series of branchlike structures being connected to the spine and extending radially outward from the primary spine axis along the spine length, each swag assembly being attachable to the vertical support structure via said swag-based fastening means, the branchlike structures being positionable relative to one another for subtending a series of angles about the primary spine axis and defining a treelike sector, the treelike sectors extending intermediate the lamp assemblies for effecting a treelike appearance about the vertical support structure.

2. The combination of claim 1 wherein the vertical support structure is a chain and the respective swag-based fastening means are defined by hooks, the swag assemblies each comprising an upper swag end and a lower swag end, the chain comprising a series of links, the links each extending in a respective link plane, the link planes of successive links being substantially orthogonal to one another, the hooks of at least two swag assemblies extending through a first upper link in opposing directions flanking a second lower link and extending in respective hook planes substantially parallel to one another and the link plane of the lower link.

3. The combination of claim 2 comprising at least four swag assemblies, the four swag assemblies comprising a pair of low link swag assemblies and a pair of high link swag assemblies, the low link swag assemblies comprising hooks positioned at a first distance from the upper swag end, the high link swag assemblies comprising hooks positioned at a second distance from the upper swag end, the first distance being greater than the second distance such that when the swag assemblies are fastened to the vertical support structure the upper swag ends are uniformly positioned about the vertical support structure.

4. The combination of claim 1 comprising a support structure collar, the support structure collar comprising collar-based fastening means and a series of outwardly extending hook-receiving structures, the swag-based fastening means of the respective swag assemblies being defined by a hook, the collar-based fastening means for fastening the support structure collar to the vertical support structure, the hook-receiving structures being cooperable with the hooks for fastening the swag assemblies to vertical support structure via the support structure collar.

5. The combination of claim 1 wherein the branchlike structures comprise twistable structure, the twistable structure of adjacent swag assemblies being twist-connectable for connecting adjacent swag assemblies to one another.

6. The combination of claim 1 comprising a cord element and wherein each swag assembly comprises a loop element fastened to the spine, each loop elements being positioned intermediate the upper swag end and the lower swag end, the cord element for interconnecting the swag assemblies via the loop elements and being tensionable for forcing the spine axes toward one another and adjusting the effective girth of said combination.

7. The combination of claim 1 comprising a light string and wherein a select lamp assembly comprises circuit enabling means for delivering current to the light string, said circuit enabling means and for enabling a user to ornament said combination with illumination via the light string.

8. A lamp-tree assembly for ornamenting a space, the lamp-tree assembly comprising:
a lamp assembly, the lamp assembly comprising a vertical support structure and a light fixture, the light fixture being supported by the vertical support structure; and
a series of swag assemblies, each swag assembly comprising a spine, a series of branchlike structures connected to the spine, and swag-based fastening means for fastening the respective swag assemblies to the vertical support structure, the spine having a primary spine axis and a spine length, the series of branchlike structures extending radially outward from the primary spine axis along the spine length, each swag assembly being attachable to the vertical support structure via said swag-based fastening means, the branchlike structures being positionable relative to one another for subtending a series of angles about the primary spine axis and defining a treelike sector, the treelike sectors surrounding the vertical support structure for effecting a treelike appearance thereabout.

9. The lamp-tree assembly of claim 8 wherein the vertical support structure is a chain and the respective swag-based fastening means are defined by hooks, the swag assemblies each comprising an upper swag end and a lower swag end, the chain comprising a series of links, the links each extending in a respective link plane, the link planes of successive links being substantially orthogonal to one another, the hooks of at least two swag assemblies extending through an upper link in opposing directions flanking a lower link and extending in respective hook planes substantially parallel to one another and the link plane of the lower link.

10. The lamp tree assembly of claim 9 comprising at least four swag assemblies, the four swag assemblies comprising a pair of low link swag assemblies and a pair of high link swag assemblies, the low link swag assemblies each comprising hooks positioned at a first distance from the upper swag end, the high link swag assemblies each comprising hooks positioned at a second distance from the upper swag end, the first distance being greater than the second distance such that when the swag assemblies are fastened to the vertical support structure the upper swag ends are uniformly positioned about the vertical support structure.

11. The lamp tree assembly of claim 8 comprising a support structure collar, the support structure collar comprising collar-based fastening means for fastening the collar to the vertical support structure, the swag-based fastening means being cooperable with support structure collar for fastening the swag assemblies to vertical support structure.

12. The lamp tree assembly of claim 8 wherein the branchlike structures comprise twistable structure, the twistable structure of adjacent swag assemblies being twist-connectable for connecting adjacent swag assemblies.

13. The lamp tree assembly of claim 1 comprising configuration maintenance means for maintaining the effective girth of the lamp-tree assembly.

14. The lamp tree assembly of claim 8 wherein a select lamp assembly comprises circuit enabling means for enabling a user to deliver current to a user-provided light string, said circuit enabling means thus for enabling a user to ornament the lamp-tree assembly with illumination via the user-provided light string.

15. A swag assembly for outfitting a lamp assembly having a vertical support structure, the swag assembly comprising:
a spine, a series of branchlike structures, and swag-based fastening means for fastening the swag assembly to the vertical support structure, the spine having a primary spine axis and a spine length, the series of branchlike structures extending radially outward from the primary spine axis along the spine length, the swag assembly being attachable to the vertical support structure via said swag-based fastening means, the branchlike structures being positionable relative to one another for subtending a series of angles about the primary spine axis and effecting a tree-like sector.

16. The swag assembly of claim 15 comprising an upper swag end and a lower swag end, the swag-based fastening means being defined by at least one hook connected to the spine, a first hook being connected to the spine at the upper swag end, each hook extending in a direction opposite the branchlike structures, each hook for attachment to a chain-based vertical support structure.

17. The swag assembly of claim 16 wherein the swag-based fastening means defined by a series of hooks connected to the spine in spaced relation from the upper swag end to the lower swag end for cooperable engagement with a series of chain links of the chain-based vertical support structure.

18. The swag assembly of claim 15 comprising a support structure collar, the support structure collar comprising collar-based fastening means for fastening the collar to the vertical support structure, the swag-based fastening means being cooperable with the support structure collar for fastening the swag assembly to the vertical support structure via the support structure collar.

19. The swag assembly of claim 15 wherein the branchlike structures comprise twistable structure, the twistable structure for twist-connecting adjacent branchlike structures.

20. The swag assembly of claim 15 comprising configuration maintenance means for maintaining the primary spine axis.
